(19) United States
(12) Patent Application Publication
(10) Pub. No.: US 2026/0009942 A1
(43) Pub. Date: Jan. 8, 2026

(54) OPTICAL WAVEGUIDE ASSEMBLY AND NEAR-EYE DISPLAY DEVICE

(71) Applicant: LINGXI-AR Technology Co., Ltd., Beijing (CN)

(72) Inventors: Yaozhang WANG, Beijing (CN); Yu ZHENG, Beijing (CN)

(21) Appl. No.: 19/257,598

(22) Filed: Jul. 2, 2025

(30) Foreign Application Priority Data
Jul. 5, 2024 (CN) 202410904163.6

(51) Int. Cl. F21V 8/00; G02B 27/01

(52) U.S. Cl. CPC G02B 6/0053; G02B 6/0055; G02B 6/0056; G02B 6/0078; G02B 27/0172

(57) ABSTRACT

Disclosed are an optical waveguide assembly and a near-eye display device. The optical waveguide assembly includes a first waveguide plate, a second waveguide plate, and an optical path turning element. A first pupil expansion structure is disposed in the first waveguide plate. The first pupil expansion structure expands light in the first waveguide plate in a first direction. The second waveguide plate and the first waveguide plate are stacked. A second pupil expansion structure is disposed in the second waveguide plate. The second pupil expansion structure expands light in the second waveguide plate in a second direction. An included angle is formed between the first direction and the second direction. The optical path turning element is disposed on one end of the first waveguide plate and one end of the second waveguide plate.

### CROSS-REFERENCE TO RELATED APPLICATION(S)

This application claims priority to Chinese Patent Application No. 202410904163.6, filed on Jul. 5, 2024, the disclosure of which is incorporated herein by reference in its entirety.

### TECHNICAL FIELD

The present disclosure relates to the field of optical technology and, in particular, to an optical waveguide assembly and a near-eye display device.

### BACKGROUND

A near-eye display device for augmented reality can enable a person to view the surrounding environment and watch a virtual image being shown at the same time. The virtual image is superimposed on the real world perceived by the user, creating a more realistic experience and making the immersion feeling of the user stronger. The main technology includes birdbaths, prisms, free-form surfaces, and optical waveguide technology. Compared with other technology, a near-eye display device with the adoption of optical waveguide technology has the advantages of increased field angle and smaller volume.

A two-dimensional array optical waveguide exit pupil can perform expansion in two directions, implementing a better imaging effect by using a more compact volume. However, for an existing two-dimensional array optical waveguide, a primary pupil expansion structure and a secondary pupil expansion structure are usually arranged in the same waveguide substrate, with the primary pupil expansion structure as an upper structure and the secondary pupil expansion structure as a lower structure. The upper structure is responsible for transverse pupil expansion. The lower structure is responsible for longitudinal pupil expansion. The upper structure performs pupil expansion on light and then emits the light to the lower structure. The lower structure performs pupil expansion on the light again, then couples the light out of the waveguide substrate, and emits the light to a human eye. Therefore, the human eye can watch the virtual image merely from the lower region of a lens, affecting product design and resulting in poor user experience.

### SUMMARY

The present disclosure is intended to solve at least one of the problems existing in the related art. Accordingly, the present disclosure is to provide an optical waveguide assembly. The optical waveguide assembly may improve the utilization rate of the spatial region on the front surface of each of a first waveguide plate and a second waveguide plate, improve user experience, and optimize the structural design of the product.

The present disclosure further provides a near-eye display device having the preceding optical waveguide assembly.

The optical waveguide assembly according to the first aspect of the present disclosure includes a first waveguide plate, a second waveguide plate, and an optical path turning element.

A first pupil expansion structure is disposed in the first waveguide plate. The first pupil expansion structure expands light in the first waveguide plate in a first direction.

The second waveguide plate and the first waveguide plate are stacked. A second pupil expansion structure is disposed in the second waveguide plate. The second pupil expansion structure expands light in the second waveguide plate in a second direction. An included angle is formed between the first direction and the second direction.

The optical path turning element is disposed on one end of the first waveguide plate and one end of the second waveguide plate. The optical path turning element is configured to receive expanded light emitted from the first pupil expansion structure and emit the expanded light to the second pupil expansion structure. After receiving the expanded light, the second pupil expansion structure couples the expanded light out of the second waveguide plate so that the expanded light enters a human eye.

In some embodiments, the first pupil expansion structure and/or the second pupil expansion structure is an array beam splitter.

In some embodiments, the optical path turning element includes multiple reflectors. After passing through the plurality of reflectors, the expanded light emitted from the first pupil expansion structure is emitted to the second pupil expansion structure.

In some embodiments, the optical path turning element includes a turning prism. The turning prism is provided with a first reflection surface and a second reflection surface. The expanded light emitted from the first waveguide plate is reflected by the first reflection surface and then emitted to the second reflection surface. The second reflection surface reflects the light and emits the light to the second pupil expansion structure.

In some optional embodiments, the turning prism is an isosceles right-angled triangular prism. Surfaces corresponding to two right-angled sides of the isosceles right-angled triangular prism form the first reflection surface and the second reflection surface respectively.

In some optional embodiments, the turning prism includes a first sub-prism and a second sub-prism. The first sub-prism and the second sub-prism are spliced to form the turning prism.

In some optional embodiments, the optical path turning element further includes a first polarization beam splitting film, a second polarization splitting film, and quarter-wave plates.

The first polarization beam splitting film is disposed on one side of the first sub-prism facing the first waveguide plate and one side of the second sub-prism facing the second waveguide plate. The first polarization beam splitting film is configured to transmit light in a first polarization state and reflect light in a second polarization state. A vibration direction of the light in the first polarization state is perpendicular to a vibration direction of the light in the second polarization state.

The second polarization splitting film is disposed between the first sub-prism and the second sub-prism. The second polarization splitting film is configured to transmit the light in the second polarization state and reflect the light in the first polarization state.

The quarter-wave plates are disposed on both one side of the first reflection surface facing the turning prism and one side of the second reflection surface facing the turning prism. The quarter-wave plates are configured to change a vibration direction of light.

In some embodiments, the first waveguide plate, the second waveguide plate, and the optical path turning element are integrally bonded by optical adhesive.

In some optional embodiments, the optical waveguide assembly further includes an in-coupling structure. The in-coupling structure is disposed on the first waveguide plate and configured to couple light into the first waveguide plate.

According to the optical waveguide assembly of the present disclosure, the first waveguide plate and the second waveguide plate are stacked. The optical path turning element is disposed on one end of the first waveguide plate and one end of the second waveguide plate. The first pupil expansion structure may be disposed in the first waveguide plate. The second pupil expansion structure may be disposed in the second waveguide plate. The optical path turning element may transmit the expanded light expanded by the first pupil expansion structure to the second pupil expansion structure so that the expanded light is expanded again to form the two-dimensional expanded light. Moreover, the first waveguide plate and the second waveguide plate are stacked, thus improving the utilization rate of the spatial region on the front surface of each of the first waveguide plate and the second waveguide plate, improving user experience, and optimizing the structural design of the product.

The near-eye display device according to the second aspect of the present disclosure includes a projection apparatus and the optical waveguide assembly according to the first aspect of the present disclosure.

For the near-eye display device according to the present disclosure, the arrangement of the optical waveguide assembly in the preceding first aspect improves the overall performance of the near-eye display device.

Additional aspects and advantages of the present disclosure will be set forth in part in the description below, and will be apparent from the description below, or may be learned through practice of the present disclosure.

### BRIEF DESCRIPTION OF DRAWINGS

FIG. 1 is a perspective view of an optical waveguide assembly according to an embodiment of the present disclosure.

FIG. 2 is a view of an optical waveguide assembly according to an embodiment of the present disclosure.

FIG. 3 is a view of an optical waveguide assembly according to another embodiment of the present disclosure.

FIG. 4 is a perspective view of an optical waveguide assembly according to another embodiment of the present disclosure.

FIG. 5 is a view of an optical waveguide assembly according to another embodiment of the present disclosure.

FIG. 6 is a view of an optical waveguide assembly according to another embodiment of the present disclosure.

FIG. 7 is a view of an optical waveguide assembly according to another embodiment of the present disclosure.

### REFERENCE LIST

100 optical waveguide assembly
10 first waveguide plate
11 first pupil expansion structure
20 second waveguide plate
21 second pupil expansion structure
30 optical path turning element
31 reflector
32 turning prism
321 first reflection surface
322 second reflection surface
323 first sub-prism
324 second sub-prism
35 first polarization beam splitting film
36 second polarization beam splitting film
37 quarter-wave plate
40 air gap
50 optical adhesive

### DETAILED DESCRIPTION

Embodiments of the present disclosure are described below in detail. Examples of the embodiments are illustrated in the drawings, where the same or similar reference numerals throughout the drawings represent the same or similar elements or elements having the same or similar functions. The embodiments described below with reference to the drawings are illustrative and intended to explain the present disclosure and cannot be construed as limiting the present disclosure.

The disclosure described below provides many different implementations or examples for implementing different structures of the present disclosure. To simplify the disclosure of the present disclosure, components and configurations of particular examples will be described below, which are, of course, illustrative only and are not intended to limit the present disclosure. Of course, they are merely examples and are not intended to limit the present disclosure. Additionally, the present disclosure may repeat reference numbers and/or reference letters in different examples. Such repetition is for the purpose of simplification and clarity, and does not indicate a relationship between various discussed embodiments and/or arrangements. In addition, the present disclosure provides examples of various specific processes and materials, but those of ordinary skill in the art can conceive the application of other processes and/or the use of other materials.

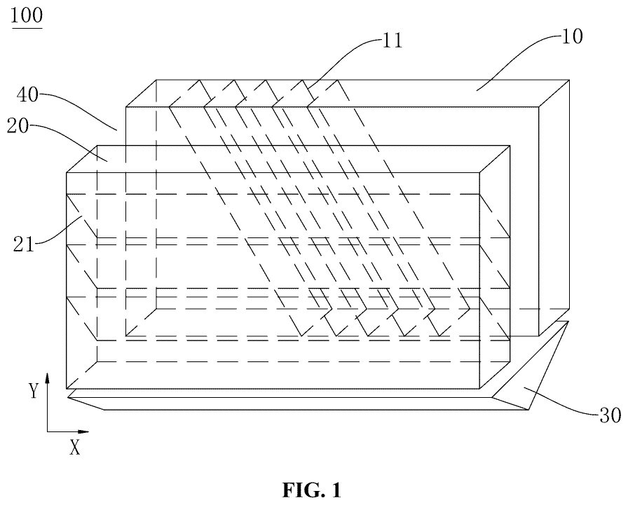

Referring to FIGS. 1 to 7 hereinafter, an optical waveguide assembly 100 according to embodiments of the present disclosure is described. The optical waveguide assembly 100 is a medium apparatus that guides the propagation of light waves therein and can guide the light projected by a projection apparatus to the front of an eye. A virtual image is superimposed on a real image in front of the human eye, thereby implementing the function of augmented reality. The optical waveguide assembly 100 includes a first waveguide plate 10, a second waveguide plate 20, and an optical path turning element 30. The first waveguide plate 10 and the second waveguide plate 20 are stacked. The optical path turning element 30 is disposed on one end of the first waveguide plate 10 and one end of the second waveguide plate 20.

It is to be noted that the first waveguide plate 10 and the second waveguide plate 20 may be made of a transparent glass material or a transparent resin material. A glass material has better optical characteristics, for example, better transmission performance, and guarantees the transmission amount of light. A resin material is easy to process. The first waveguide plate 10 and the second waveguide plate 20 may be obtained by a process such as thermoplastic molding.

Referring to FIG. 1, further, a first pupil expansion structure 11 is disposed in the first waveguide plate 10. The first pupil expansion structure 11 expands light in the first waveguide plate 10 in a first direction (for example, direction X in FIG. 1). It may be understood that when the light in the first waveguide plate 10 is transmitted to the first pupil expansion structure 11, the first pupil expansion structure 11 may expand the light in the first waveguide plate 10 in the first direction.

Referring to FIG. 1, further, the second waveguide plate 20 and the first waveguide plate 10 are stacked. A second pupil expansion structure 21 is disposed in the second waveguide plate 20. The second pupil expansion structure 21 expands light in the second waveguide plate 20 in a second direction (for example, direction Y in FIG. 1). An included angle is formed between the first direction and the second direction. It may be understood that when the light in the second waveguide plate 20 is transmitted to the second pupil expansion structure 21, the second pupil expansion structure 21 may expand the light in the second waveguide plate 20 in the second direction.

It is to be noted that to guarantee that the light can be transmitted through total reflection in the first waveguide plate 10 and the second waveguide plate 20, the first waveguide plate 10 and the second waveguide plate 20 need to be separated by a certain distance when the second waveguide plate 20 and the first waveguide plate 10 are stacked. Specifically, for example, an air gap 40 may exist between the second waveguide plate 20 and the first waveguide plate 10. Since the refractive index of air is lower than the refractive index of the first waveguide plate 10 and the second waveguide plate 20, the light can be propagated through total reflection in the first waveguide plate 10 and the second waveguide plate 20.

Referring to FIG. 1, further, the optical path turning element 30 is disposed on one end of the first waveguide plate 10 and one end of the second waveguide plate 20. The optical path turning element 30 is configured to receive expanded light emitted from the first pupil expansion structure 11 and emit the expanded light to the second pupil expansion structure 21. After receiving the expanded light, the second pupil expansion structure 21 couples the expanded light out of the second waveguide plate 20 so that the expanded light enters the human eye.

It may be understood that after the light projected by the projection apparatus enters the first waveguide plate 10, the light is transmitted in the first waveguide plate 10 through total reflection. When the light is transmitted to the first pupil expansion structure 11, the first pupil expansion structure 11 expands the light in the first direction to form the expanded light and emits the expanded light to the optical path turning element 30. The optical path turning element 30 receives the expanded light emitted from the first pupil expansion structure 11, changes the transmission direction of the expanded light, and emits the expanded light to the second waveguide plate 20. When the expanded light in the second waveguide plate 20 is transmitted to the second pupil expansion structure 21, the second pupil expansion structure 21 expands the expanded light again in the second direction and couples the expanded light out of the second waveguide plate 20 to form two-dimensional expanded light which finally enters the human eye.

It is to be noted that the optical path turning element 30 is composed the optical element that can change the direction of light transmission, such as the reflector 31 and the prism. The optical path turning element 30 may be composed of one optical element or multiple optical elements, which is not limited in embodiments of the present disclosure.

As shown in FIG. 1, in this embodiment, that the included angle is formed between the first direction and the second direction indicates that the first direction is not parallel to the second direction. Specifically, the included angle between the first direction and the second direction may be, for example, 30°, 45°, 60°, or 90°. For example, in this embodiment, the included angle between the first direction and the second direction is 90°.

Inventors found in actual research that an existing two-dimensional array optical waveguide usually consists of a single waveguide substrate, with a primary pupil expansion structure disposed in the upper half of the waveguide substrate, and a secondary pupil expansion structure disposed in the lower half of the waveguide substrate. After performing pupil expansion, the primary pupil expansion structure emits light to the secondary pupil expansion structure. The secondary pupil expansion structure performs pupil expansion on the light again, then couples the light out of the waveguide substrate, and emits the light to a human eye. Therefore, the human eye can watch a virtual image merely from the lower region of a lens, affecting product design and resulting in poor user experience.

In this regard, according to the optical waveguide assembly 100 in embodiments of the present disclosure, the first waveguide plate 10 and the second waveguide plate 20 are stacked. The optical path turning element 30 is disposed on one end of the first waveguide plate 10 and one end of the second waveguide plate 20. The first pupil expansion structure 11 may be disposed in the first waveguide plate 10. The second pupil expansion structure 21 may be disposed in the second waveguide plate 20. The optical path turning element 30 may transmit the expanded light expanded by the first pupil expansion structure 11 to the second pupil expansion structure 21 so that the expanded light is expanded again to form the two-dimensional expanded light. Moreover, the first waveguide plate 10 and the second waveguide plate 20 are stacked, thus improving the utilization rate of the spatial region on the front surface of each of the first waveguide plate 10 and the second waveguide plate 20, improving user experience, and optimizing the structural design of the product.

Referring to FIG. 1, in some embodiments, the first pupil expansion structure 11 and/or the second pupil expansion structure 21 is an array beam splitter. It may be understood that the first pupil expansion structure 11 may be an array beam splitter. Alternatively, the second pupil expansion structure 21 may be an array beam splitter. Alternatively, each of the first pupil expansion structure 11 and the second pupil expansion structure 21 may be an array beam splitter. For example, in this embodiment, each of the first pupil expansion structure 11 and the second pupil expansion structure 21 is an array beam splitter. Accordingly, the principle of pupil expansion implemented by array beam splitters is simple, resulting in relatively clear design thoughts. The preparation technology is relatively mature so that optical imaging quality is high with no color cast. Therefore, imaging quality can be improved, further improving user experience and further optimizing the structural design of the product.

It is to be noted that multiple small waveguide prisms may be obtained by cutting a waveguide base material. Then the small waveguide prisms are roughly ground, finely ground, and polished. Later the small waveguide prisms are plated with beam splitting films respectively. Finally, the small waveguide prisms are adhered to form the first waveguide plate 10 with a smooth surface or the second waveguide plate 20 with a smooth surface. In this case, the beam splitting films on the small waveguide prisms are located in the first waveguide plate 10 or the second waveguide plate 20 to form an array beam splitter.

In some optional embodiments, the beam splitting films on the small waveguide prisms may have the same film system or different film systems. When the film systems of the beam splitting films on the small waveguide prisms are different, each array beam splitting film can obtain different light reflection/transmission ratios. Therefore, the intensity of each light beam expanded by the array beam splitter can be controlled, thus improving image uniformity and further improving imaging quality.

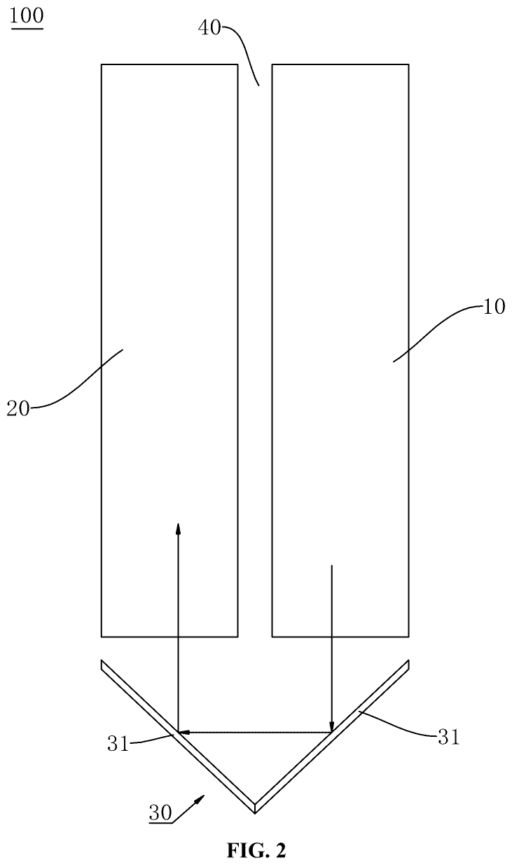

Referring to FIG. 2 additionally, in some embodiments, the optical path turning element 30 includes multiple reflectors 31. After passing through the reflectors 31, the expanded light emitted from the first pupil expansion structure 11 is emitted to the second pupil expansion structure 21. Accordingly, with the arrangement of the multiple reflectors 31, the expanded light emitted from the first pupil expansion structure 11 is emitted to the second waveguide plate 20 and to the second pupil expansion structure 21. The structure of the optical waveguide assembly 100 is simple, thus further optimizing the structural design of the product.

It may be understood that the reflectors 31 may be, for example, two reflectors 31, three reflectors 31, four reflectors 31, or five reflectors 31. The number of reflectors 31 is not limited in embodiments of the present disclosure. Specifically, for example, in this embodiment, the optical path turning element 30 may include two reflectors 31. After passing through the two reflectors 31, the expanded light emitted from the first pupil expansion structure 11 is emitted to the second pupil expansion structure 21.

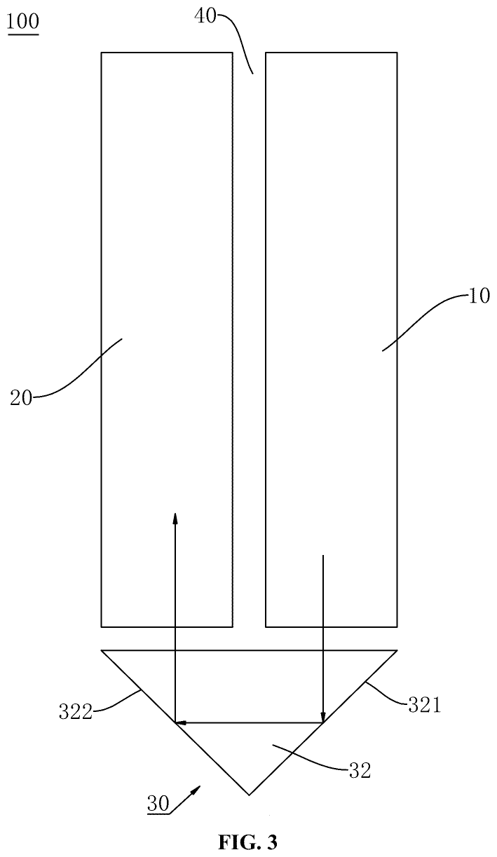

Referring to FIG. 3 additionally, in some embodiments, the optical path turning element 30 includes a turning prism 32. The turning prism 32 is provided with a first reflection surface 321 and a second reflection surface 322. The expanded light emitted from the first waveguide plate 10 is reflected by the first reflection surface 321 and then emitted to the second reflection surface 322. The second reflection surface 322 reflects the light and emits the light to the second pupil expansion structure 21. Accordingly, the turning prism 32 is arranged, and the first reflection surface 321 and the second reflection surface 322 are disposed on the turning prism 32 for turning the light, further simplifying the structure of the optical waveguide assembly 100 and further optimizing the structural design of the product.

It may be understood that the turning prism 32 may be a triangular prism. With the adoption of the principle of total reflection, two surfaces of the triangular prism are made to form the first reflection surface 321 and the second reflection surface 322 to implement the turning of the light through the triangular prism. It may also be that reflective films are plated on the two surfaces of the triangular prism to form the first reflection surface 321 and the second reflection surface 322. It may also be that two mirror surfaces are attached to the two surfaces of the triangular prism to form the first reflection surface 321 and the second reflection surface 322. Of course, the turning prism 32 may also be a prism of another structure as long as the first reflection surface 321 and the second reflection surface 322 are disposed on the turning prism 32 and can reflect the expanded light emitted from the first waveguide plate 10 to the second waveguide plate 20 and emit the light to the second pupil expansion structure 21.

In some optional embodiments, the turning prism 32 is an isosceles right-angled triangular prism. Surfaces corresponding to two right-angled sides of the isosceles right-angled triangular prism form the first reflection surface 321 and the second reflection surface 322 respectively. It may be understood that the surfaces corresponding to the two right-angled sides of the isosceles right-angled triangular prism may form the first reflection surface 321 and the second reflection surface 322 through total reflection respectively. Alternatively, reflective films may be plated on the surfaces corresponding to the two right-angled sides of the isosceles right-angled triangular prism to form the first reflection surface 321 and the second reflection surface 322. Alternatively, mirror surfaces may be attached to the surfaces corresponding to the two right-angled sides of the isosceles right-angled triangular prism to form the first reflection surface 321 and the second reflection surface 322. Accordingly, the isosceles right-angled triangular prism has a simple structure and a regular shape, further simplifying the structure of the optical waveguide assembly 100 and further optimizing the structural design of the product.

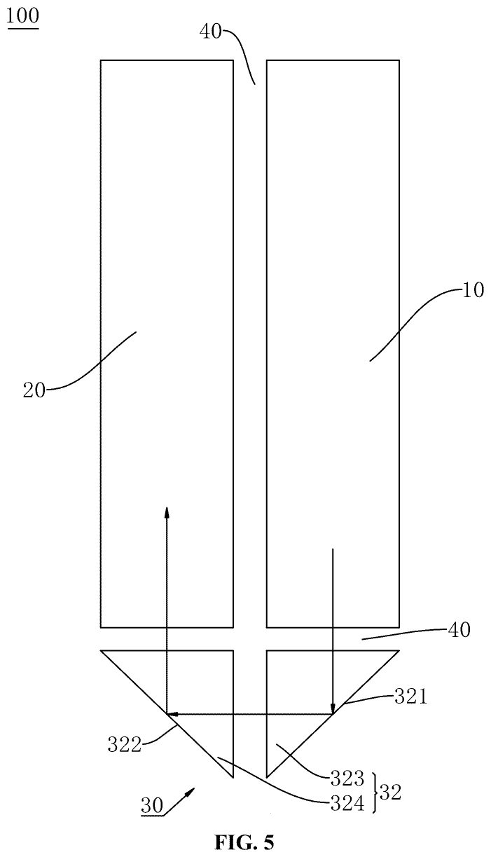

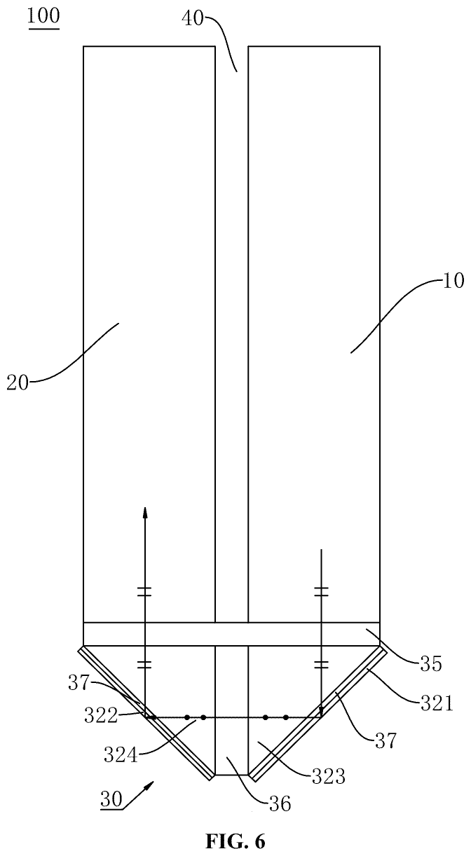

As shown in FIGS. 5 and 6, in some optional embodiments, the turning prism 32 includes a first sub-prism 323 and a second sub-prism 324. The first sub-prism 323 and the second sub-prism 324 are spliced to form the turning prism 32. It may be understood that the air gap 40 may exist between the first sub-prism 323 and the second sub-prism 324. Alternatively, the first sub-prism 323 and the second sub-prism 324 may be bonded by using optical adhesive 50 so as to form the integral turning prism 32.

It is to be noted that in the optical path turning element 30 formed by merely two reflectors 31 or one isosceles right-angled triangular prism, part of the light may be merely reflected once in the optical path turning element 30 and then enter the second waveguide plate 20. This part of the light may become ghost image light, ultimately affecting the imaging quality of the optical waveguide assembly 100.

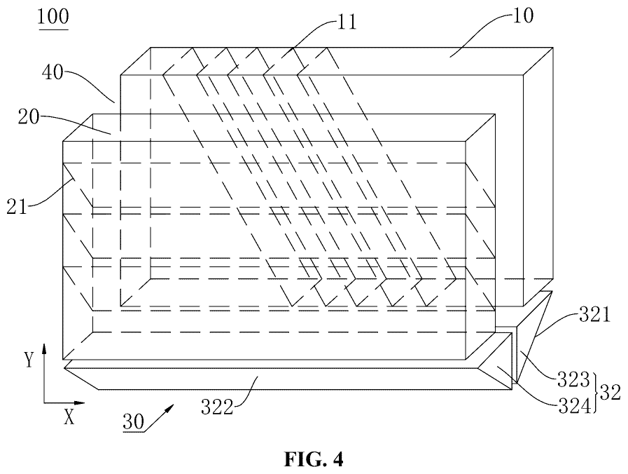

Referring to FIGS. 4 and 5, in this embodiment, the air gap 40 may exist between the turning prism 32 formed by the first sub-prism 323 and the second sub-prism 324 and the first waveguide plate 10 and exist between the turning prism 32 and the second waveguide plate 20. Therefore, when part of the light is merely reflected once in the turning prism 32 and then emitted to an emittance surface of the turning prism 32, the emittance surface of the turning prism 32 meets the condition of total reflection due to the existence of the air gap 40. Therefore, this part of the light cannot be emitted from the turning prism 32 but is reflected again. After being reflected in the turning prism 32 multiple times, this part of the light finally does not meet the angle condition of total reflection of the emittance surface of the turning prism 32 and is emitted from the emittance surface of the turning prism 32 to the second waveguide plate 20. Accordingly, the air gap 40 exists between the turning prism 32 formed by the first sub-prism 323 and the second sub-prism 324 the first waveguide plate 10 and exists between the turning prism 32 and the second waveguide plate 20. Therefore, the emittance surface of the turning prism 32 formed by the first sub-prism 323 and the second sub-prism 324 may form a total reflection surface, thus reducing the generation of ghost image light, improving the imaging quality of the optical waveguide assembly 100, and improving the light transmission efficiency of the optical waveguide assembly 100.

Referring to FIG. 6 additionally, in some optional embodiments, the optical path turning element 30 further includes a first polarization beam splitting film 35, a second polarization splitting film 36, and quarter-wave plates 37. The first polarization beam splitting film 35 is disposed on one side of the first sub-prism 323 facing the first waveguide plate 10 and one side of the second sub-prism 324 facing the second waveguide plate 20. The first polarization beam splitting film 35 is configured to transmit light in a first polarization state and reflect light in a second polarization state. The vibration direction of the light in the first polarization state is perpendicular to the vibration direction of the light in the second polarization state.

Referring to FIG. 6, further, the second polarization splitting film 36 is disposed between the first sub-prism 323 and the second sub-prism 324. The second polarization splitting film 36 is configured to transmit the light in the second polarization state and reflect the light in the first polarization state.

Referring to FIG. 6, further, the quarter-wave plates 37 are disposed on both one side of the first reflection surface 321 facing the turning prism 32 and one side of the second reflection surface 322 facing the turning prism 32. The quarter-wave plates 37 are configured to change the vibration direction of light.

It is to be noted that after the light projected by the projection apparatus enters the first waveguide plate 10, the light is transmitted in the first waveguide plate 10 through total reflection. When the light is transmitted to the first pupil expansion structure 11, the first pupil expansion structure 11 expands the light in the first direction to form the expanded light and emits the expanded light to the optical path turning element 30. The optical path turning element 30 includes the first sub-prism 323 and the second sub-prism 324. Moreover, the first polarization beam splitting film 35 is disposed on one side of the first sub-prism 323 facing the first waveguide plate 10 and one side of the second sub-prism 324 facing the second waveguide plate 20. Therefore, when the expanded light is emitted to the optical path turning element 30, the expanded light needs to pass through the first polarization beam splitting film 35. In this case, only the light in the first polarization state among the expanded light can be transmitted through the first polarization beam splitting film 35 and enter the optical path turning element 30.

Referring to FIG. 6, further, after entering the optical path turning element 30, the light in the first polarization state is emitted to the first reflection surface 321. Since a quarter-wave plate 37 is disposed on one side of the first reflection surface 321 facing the turning prism 32, the light in the first polarization state passes through the quarter-wave plate 37 once when being emitted to the first reflection surface 321. When being emitted out by the first reflection surface 321, the light in the first polarization state passes through the quarter-wave plate 37 again. In this case, after the light in the first polarization state passes through the quarter-wave plate 37 twice, the polarization state changes. The light in the first polarization state changes into the light in the second polarization state.

Referring to FIG. 6, further, the light reflected by the first reflection surface 321 is emitted between the first sub-prism 323 and the second sub-prism 324. In this case, the expanded light is in the second polarization state. The second polarization splitting film 36 is disposed between the first sub-prism 323 and the second sub-prism 324. The second polarization splitting film 36 may transmit the light in the second polarization state. Therefore, the light in the second polarization state can be emitted out from the second sub-prism 324 and to the second reflection surface 322.

Referring to FIG. 6, further, a quarter-wave plate 37 is disposed on one side of the second reflection surface 322 facing the turning prism 32. The light in the second polarization state passes through the quarter-wave plate 37 once when being emitted to the second reflection surface 322. When being emitted out by the second reflection surface 322, the light in the second polarization state passes through the quarter-wave plate 37 again. In this case, after the light in the second polarization state is reflected by the second reflection surface 322, the polarization state changes. The light in the second polarization state changes into the light in the first polarization state again and is emitted to the second waveguide plate 20.

Referring to FIG. 6, further, a first polarization beam splitting film 35 is disposed between the second sub-prism 324 and the second waveguide plate 20. Therefore, the light in the first polarization state can enter the second waveguide plate 20 and be emitted to the second pupil expansion structure 21; and after passing through the second pupil expansion structure 21, the light is emitted out to the human eye, finally implementing the display of augmented reality.

Accordingly, the arrangement of the first polarization beam splitting film 35, the second polarization splitting film 36, and the quarter-wave plates 37 limits the transmission path of the light. When part of the light is reflected merely by the first reflection surface 321 in the optical path turning element 30 and then emitted to the second waveguide plate 20, this part of the light is the light in the second polarization state. This part of the light may be reflected by the first polarization beam splitting film 35 and cannot enter the second waveguide plate 20, thus improving the imaging quality of the optical waveguide assembly 100.

It is to be noted that the first polarization beam splitting film 35 may be directly formed on a surface of the first sub-prism 323 facing the first waveguide plate 10 and a surface of the second sub-prism 324 facing the second waveguide plate 20 in the manner of film coating. Similarly, the second polarization beam splitting film 36 may be formed on a surface of the first sub-prism 323 facing the second sub-prism 324 or on a surface of the second sub-prism 324 facing the first sub-prism 323 in the manner of film coating or bonding.

Specifically, in some embodiments, the light in the first polarization state may be p-polarized light. The light in the second polarization state may be s-polarized light. The first polarization beam splitting film 35 may transmit the p-polarized light and reflect the s-polarized light. The second polarization beam splitting film 36 may transmit the s-polarized light and reflect the p-polarized light.

In some other embodiments, the projection apparatus may project p-polarized light. In this case, the expanded light emitted from the first waveguide plate 10 to the optical path turning element 30 is all p-polarized light, thus improving the light transmission efficiency of the optical waveguide assembly 100 and further improving the imaging quality of the optical waveguide assembly 100.

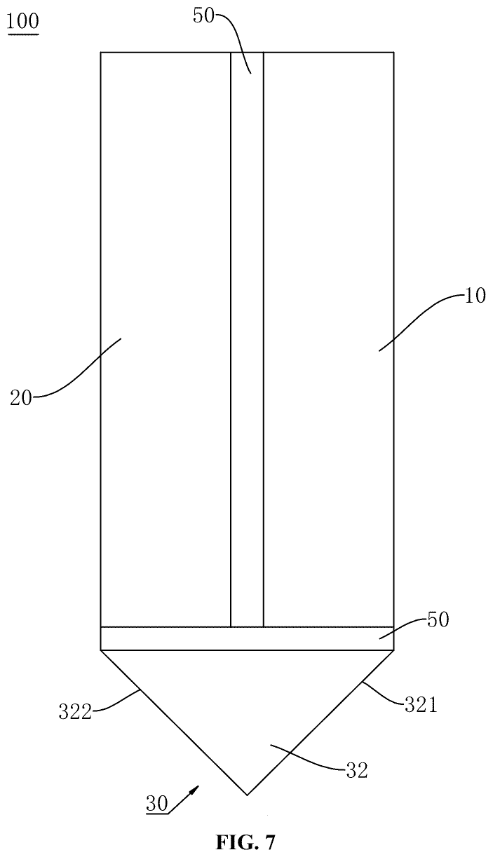

Referring to FIG. 7 additionally, in some embodiments, the first waveguide plate 10, the second waveguide plate 20, and the optical path turning element 30 are integrally bonded by optical adhesive 50. Accordingly, the optical waveguide assembly 100 is integrally formed by using the optical adhesive 50, facilitating the fixation between the first waveguide plate 10, the second waveguide plate 20, and the optical path turning element 30, preventing the position of each element from being shifted and affecting the optical path, and thus further optimizing the structural design of the product.

It is to be noted that the first waveguide plate 10 and the second waveguide plate 20 are stacked. It is necessary to guarantee that the light can be transmitted in the first waveguide plate 10 and the second waveguide plate 20 through total reflection. Therefore, the refractive index of the optical adhesive 50 used for bonding needs to be lower than the refractive index of the first waveguide plate 10 and the second waveguide plate 20. In this case, when the light is transmitted in the first waveguide plate 10 and the second waveguide plate 20, the condition of total reflection can be met.

In some optional embodiments, the optical waveguide assembly 100 further includes an in-coupling structure (not shown). The in-coupling structure is disposed on the first waveguide plate 10 and configured to couple light into the first waveguide plate 10. Accordingly, with the arrangement of the in-coupling structure, the light projected by the projection apparatus can be coupled into the first waveguide plate 10 for transmission, thus optimizing the structural design of the product.

It may be understood that the in-coupling structure may be for example, a prism disposed on the first waveguide plate 10 or a grating disposed on the first waveguide plate 10, which is not limited in embodiments of the present disclosure.

A near-eye display device according to embodiments of the present disclosure includes a projection apparatus (not shown) and the preceding optical waveguide assembly 100. The projection apparatus is configured to project a virtual image to the optical waveguide assembly 100. Accordingly, the arrangement of the optical waveguide assembly 100 in the preceding first aspect improves the overall performance of the near-eye display device.

Other configurations and operations of the optical waveguide assembly 100 and the near-eye display device according to embodiments of the present disclosure are known to those of ordinary skill in the art and not described in detail here.

In the description of the present disclosure, it is to be understood that the orientation or position relationships indicated by terms “center”, “longitudinal”, “lateral”, “length”, “width”, “thickness”, “above”, “below”, “front”, “back”,” “left”, “right”, “vertical”, “horizontal”, “top”, “bottom”, “inside”, “outside”, “clockwise”, “counterclockwise”, “axial”, “radial”, “circumferential”, etc. are based on the orientation or position relationships shown in the drawings, merely for facilitating description of the present disclosure and simplifying description, and do not indicate or imply that the apparatus or element referred to has a specific orientation and is constructed and operated in a specific orientation, and thus it is not to be construed as limiting the present disclosure.

Moreover, terms such as “first” and “second” are used only for the purpose of description and are not to be construed as indicating or implying relative importance or implicitly indicating the number of technical features indicated. Thus, a feature defined as a “first” feature or a “second” feature may explicitly or implicitly include one or more of such features. In the description of the present disclosure, the term “multiple” is defined as two or more unless otherwise expressly limited.

In the present disclosure, unless otherwise expressly specified and limited, a term such as “assembly”, “connected to each other”, “connected” or “fixed” is to be construed in a broad sense, for example, as permanently connected, detachably connected, or integrated; mechanically connected, electrically connected or communication; directly connected to each other or indirectly connected to each other via an intermediary; or internally connected or interactional between two components. For those of ordinary skill in the art, specific meanings of the preceding terms in the present disclosure may be understood based on specific situations.

In the present disclosure, unless otherwise expressly specified and limited, a first feature “above” or “below” a second feature is to be construed as the first feature directing contacting the second feature, or the first feature indirectly contacting the second feature via an intermediary. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of the specification, the description of reference terms “an embodiment”, “some embodiments”, “example”, “specific example”, or “some examples” and the like means a specific characteristic, a structure, a material or a feature described in connection with the embodiment or the example are included in at least one embodiment or example of the present disclosure. In the specification, the illustrative description of the preceding terms does not necessarily refer to the same embodiment or example. Moreover, the described specific features, structures, materials or characteristics may be combined in an appropriate manner in any one or more embodiments or examples. In addition, the different embodiments or examples described in this specification and the features of the different embodiments or examples may be combined and combined by those skilled in the art without contradicting each other.

Although embodiments of the present disclosure have been shown and described, it is to be understood by those of ordinary skill in the art that multiple variations, modifications, substitutions and alterations can be made in these embodiments without departing from the principle and spirit of the present disclosure. The scope of the present disclosure is defined by the claims and equivalents thereof.

What is claimed is:

1. An optical waveguide assembly, comprising:
a first waveguide plate, wherein a first pupil expansion structure is disposed in the first waveguide plate, and the first pupil expansion structure expands light in the first waveguide plate in a first direction;
a second waveguide plate, wherein the second waveguide plate and the first waveguide plate are stacked, a second pupil expansion structure is disposed in the second waveguide plate, the second pupil expansion structure expands light in the second waveguide plate in a second direction, and an included angle is formed between the first direction and the second direction; and
an optical path turning element, wherein the optical path turning element is disposed on one end of the first waveguide plate and one end of the second waveguide plate; the optical path turning element is configured to receive expanded light emitted from the first pupil expansion structure and emit the expanded light to the second pupil expansion structure; and after receiving the expanded light, the second pupil expansion structure couples the expanded light out of the second waveguide plate so that the expanded light enters a human eye.

2. The optical waveguide assembly according to claim 1, wherein at least one of the first pupil expansion structure or the second pupil expansion structure is an array beam splitter.

3. The optical waveguide assembly according to claim 1, wherein the optical path turning element comprises a plurality of reflectors; and after passing through the plurality of reflectors, the expanded light emitted from the first pupil expansion structure is emitted to the second pupil expansion structure.

4. The optical waveguide assembly according to claim 1, wherein the optical path turning element comprises a turning prism, the turning prism is provided with a first reflection surface and a second reflection surface, the expanded light emitted from the first waveguide plate is reflected by the first reflection surface and then emitted to the second reflection surface, and the second reflection surface reflects the light and emits the light to the second pupil expansion structure.

5. The optical waveguide assembly according to claim 4, wherein the turning prism is an isosceles right-angled triangular prism, and surfaces corresponding to two right-angled sides of the isosceles right-angled triangular prism form the first reflection surface and the second reflection surface respectively.

6. The optical waveguide assembly according to claim 4, wherein the turning prism comprises a first sub-prism and a second sub-prism, and the first sub-prism and the second sub-prism are spliced to form the turning prism.

7. The optical waveguide assembly according to claim 6, wherein the optical path turning element further comprises:
a first polarization beam splitting film, wherein the first polarization beam splitting film is disposed on one side of the first sub-prism facing the first waveguide plate and one side of the second sub-prism facing the second waveguide plate, and the first polarization beam splitting film is configured to transmit light in a first polarization state and reflect light in a second polarization state, wherein a vibration direction of the light in the first polarization state is perpendicular to a vibration direction of the light in the second polarization state;
a second polarization splitting film, wherein the second polarization splitting film is disposed between the first sub-prism and the second sub-prism, and the second polarization splitting film is configured to transmit the light in the second polarization state and reflect the light in the first polarization state; and
quarter-wave plates, wherein the quarter-wave plates are disposed on both one side of the first reflection surface facing the turning prism and one side of the second reflection surface facing the turning prism, and the quarter-wave plates are configured to change a vibration direction of light.

8. The optical waveguide assembly according to claim 1, wherein the first waveguide plate, the second waveguide plate, and the optical path turning element are integrally bonded by optical adhesive.

9. The optical waveguide assembly according to claim 8, further comprising an in-coupling structure, wherein the in-coupling structure is disposed on the first waveguide plate and configured to couple light into the first waveguide plate.

10. A near-eye display device, comprising:
a projection apparatus and the optical waveguide assembly according to claim 1, wherein the projection apparatus is configured to emit light to the optical waveguide assembly.
